(19) United States
(12) Patent Application Publication
(10) Pub. No.: US 2006/0132936 A1
(43) Pub. Date: Jun. 22, 2006

(54) Electromagnetic focusing module

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/301,870

(22) Filed: Dec. 13, 2005

(30) Foreign Application Priority Data
Dec. 17, 2004 (CN) 200410077641.3

(51) Int. Cl. G02B 7/02

(52) U.S. Cl. 359/824

(57) ABSTRACT

A focusing module (100) for use in a digital camera module (200) includes a lens barrel (10), a first lens (12), a magnetic element (14), a second lens (11), and an electromagnetic element (15). The first lens (12) is disposed in the lens barrel (10). The magnetic element (14) is slidably disposed in the lens barrel (10). The second lens (14) is secured in the magnetic element (14). The electromagnetic element (15) is secured in the lens barrel (10), and the electromagnetic element (15) is connected to an electric circuit (20).

### BACKGROUND OF THE INVENTION

1. Field of the Invention

The present invention generally relates to focusing modules used in photography and imaging equipment and, more particularly, to a focusing module for a digital camera.

2. Discussion of the Related Art

Currently, digital camera modules are included as a feature in a wide variety of portable electronic devices and, of course, in stand-alone digital camera units. Most portable electronic devices are becoming progressively more miniaturized over time, and digital camera modules are correspondingly becoming smaller and smaller. Nevertheless, in spite of the small size of a contemporary digital camera module, consumers still demand excellent imaging.

There are in most of conventional photography and imaging equipments focus adjusting mechanisms for facilitating the taking of high quality photos. A conventional focus adjusting mechanism typically includes a motor and a driving member. However, the conventional focus adjusting mechanism cannot be used in a miniature digital camera module for a portable electronic device, because the motor and the driving member need a rather large space to adjust focus.

An automatic focusing module for miniature digital camera is shown in Chinese patent NO. 02234511.6. The automatic focusing module includes a magnetic coil above an image sensor package. An image sensor combined with a magnetic element is defined in the image sensor package. The magnetic element is secured on the upper portion of the image sensor. An end of a spring is attached to the lower portion of the image sensor. Another end of the spring is attached to image sensor package. When the automatic focusing module performs its focusing function, a microprocessor controls an electric current introduced into the magnetic coil. The magnetic coil subsequently produces a magnetic field, which has an opposite direction to a magnetic direction of the magnetic element. The repulsive force between the magnetic coil and the magnetic element will drive the image sensor to compress the spring. Correspondingly, a compressed distance of the spring depends on the value of the electric current. Thus, the automatic focusing module achieves the focusing function by controlling the compression distance/amount of the spring. Finally, once the introduction of the electric current into the magnetic coil is stopped, the spring will decompress, and the image sensor will return to an initial position.

However, such an automatic focusing module has a complex structure with the magnetic coil, the magnetic element, and the spring. Moreover, the image sensor package needs to be precisely designed to meet the compression distance of the spring.

What is needed is a focusing module which can be used in a miniaturized digital camera module for a portable electronic device.

### SUMMARY OF THE INVENTION

A focusing module includes a lens barrel, a first lens, a magnetic element, a second lens, and an electromagnetic element. The first lens is disposed in the lens barrel. The magnetic element is slidably disposed in the lens barrel. The second lens is secured in the magnetic element. The electromagnetic element is secured in the lens barrel, and the electromagnetic element is connected to an electric circuit.

Other objects, advantages and novel features will become more apparent from the following detailed description when taken in conjunction with the accompanying drawings.

### BRIEF DESCRIPTION OF THE DRAWINGS

Many aspects of the focusing module can be better understood with reference to the following drawings. The components in the drawings are not necessarily to scale, the emphasis instead being placed upon clearly illustrating the principles of the present focusing module. Moreover, in the drawings, like reference numerals designate corresponding parts throughout the several views.

FIG. 1 is a schematic view of a focusing module in accordance with a preferred embodiment of the focusing module, showing an initial state;

FIG. 2 is a schematic view of the focusing module in FIG. 1, showing a focusing state, and

FIG. 3 is a schematic view of a camera module using the focusing module in FIG. 1.

### DETAILED DESCRIPTION OF THE EMBODIMENTS

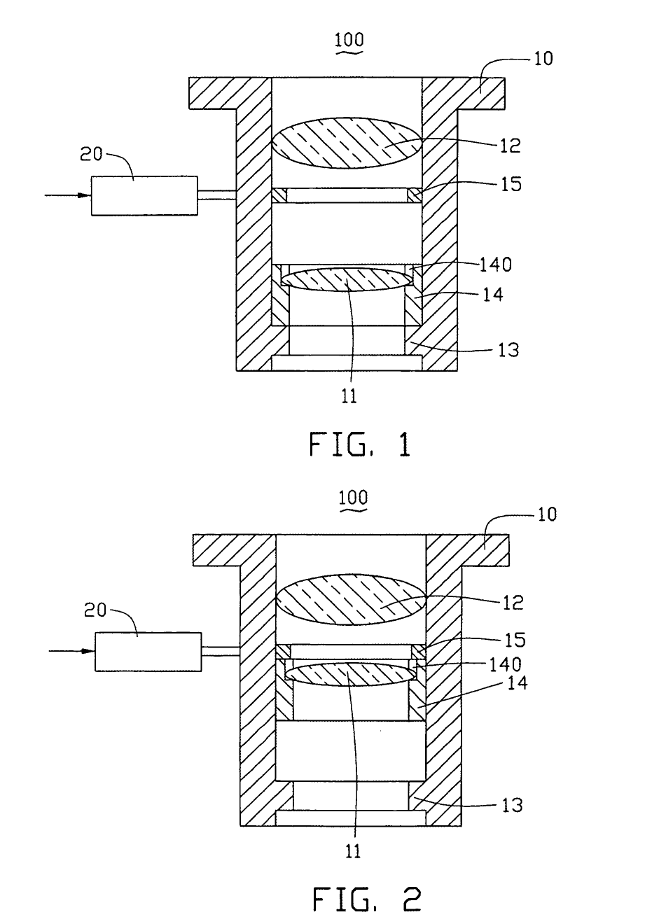

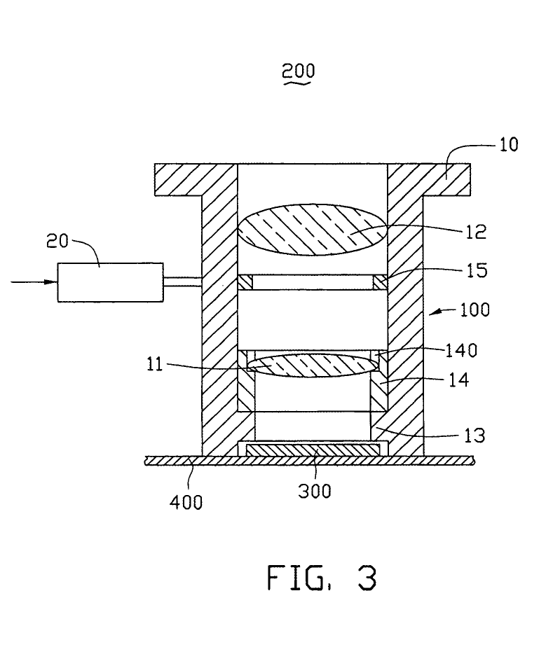

Referring to FIGS. 1 and 2, a focusing module 100 according to a preferred embodiment includes a lens barrel 10, a first lens 11, a second lens 12, a magnetic element 14, and an electromagnetic element 15. The second lens 12, the magnetic element 14, and the electromagnetic element 15 are separately disposed in the lens barrel 10.

The magnetic element 14 is an annular magnet and preferably is a permanent magnet. The magnetic element 14 has a step portion 140, and the second lens 12 is secured on the step portion 140. The magnetic element 14 has an outer diameter slightly smaller than that of the inner diameter of the lens barrel 10, so that the magnetic element 14 can slide in the lens barrel 10. A stopper 13 is formed on the inner peripheral wall of the lens barrel 10 to provide a limit on the potential range of motion of the magnetic element 14. The magnetic element 14 is disposed between the stopper 13 and the electromagnetic element 15. By acting to limit movement of the magnetic element 14, the stopper 13 can protect other elements in the lens barrel 10 from being damaged by the magnetic element 14.

The electromagnetic element 15 is an electromagnetic coil connected to an electric circuit 20 and is fixedly mounted within the lens barrel 10. The electric circuit 20 provides an alterable/adjustable current to the electromagnetic element 15. The electromagnetic element 15 generates a magnetic field under the current. The magnetic field can be chosen so as to either attract or repel the magnetic element 14. Thus, the magnetic field can drive the movement of the magnetic element 14 between the electromagnetic element 15 and the stopper 13. Because the magnetic element 14 moves together with the first lens 11, a combined focus length of the first lens 11 and the second lens 12 will change with the movement of the first lens 11. Therefore, the focusing module 100 completes a focusing process.

Referring to FIG. 1, in assembly, initially, the first lens 11 is secured on the step portion 140 of the magnetic element 14. Secondly, the magnetic element 14 and the electromagnetic element 15 are slidably and fixedly secured, respectively, in the lens barrel 10, in turn. Thirdly, the second lens 12 is disposed in the lens barrel 10. Fourthly, the second lens 12 is moved to get an initial combined focus length of the first lens 11 and the second lens 12. The second lens 12 is then fastened within the lens barrel 10 by using, e.g., a glue/adhesive. Thus, the focusing module 100 gets an initial status.

Referring to FIGS. 1 and 2, in use, when the focusing module 100 cannot obtain a satisfied image-quality in the initial status with the initial combined focus length, the electric circuit 20 provides an electric current to the electromagnetic element 15. The electromagnetic element 15 produces a magnetic field under the alterable current. The magnetic field then magnetizes the magnetic element 14. The magnetism drives the magnetic element 14 to move toward the electromagnetic element 15. When the magnetic element 14 touches the electromagnetic element 15, the focusing module 100 gets a second combined focus length of the first lens 11 and the second lens 12. The focusing module 100 can potentially obtain a good image quality with the second combined focus length. When the focusing module 100 completes a focusing process, the electric circuit 20 stops providing electric current to the electromagnetic element 15, and the focusing module 100 returns to the initial status. It is also to be understood that further focal lengths could be achieved by magnetically moving the magnetic element 14 to any of a variety of intermediate positions between the stopper 13 and the electromagnetic element 15 and then holding the magnetic element 14 at such a position. It is to be further understood that step of stopping the provision of electrical current could be gradually performed to permit a controlled return to the initial status position.

Referring to FIG. 3, when the focusing module 100 is used in a digital camera module 200, an image sensor 300 is secured below the focusing module 100. The image sensor 300 is connected to a flexible circuit board 400 for converting an image signal to an electronic signal. It is also to be understood that, while not shown, the focusing module 100 could be potentially used, for example, in cameras employing film instead of a digital media; in microscopy; and in telescopy.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A focusing module, comprising:
a lens barrel;
a first lens disposed in the lens barrel;
a magnetic element slidably disposed in the lens barrel;
a second lens secured in the magnetic element; and
an electromagnetic element secured in the lens barrel, the electromagnetic element being connected to an electric circuit.

2. The focusing module as claimed in claim 1, wherein the electromagnetic element is an electromagnetic coil.

3. The focusing module as claimed in claim 1, wherein the lens barrel includes a stop portion formed on an inner peripheral wall of the lens barrel.

4. The focusing module as claimed in claim 3, wherein the electromagnetic element is disposed between the stop portion and the first lens.

5. The focusing module as claimed in claim 1, wherein the magnetic element is a permanent magnet.

6. The focusing module as claimed in claim 1, wherein the magnetic element is an annular magnet.

7. The focusing module as claimed in claim 1, wherein the magnetic element has a step portion configured for holding the second lens.

8. A digital camera unit, comprising:
an image sensor; and
a focusing module arranged proximate the image sensor, the focusing module being configured for focusing an image on the image sensor, the focusing module comprising:
a lens barrel;
a first lens disposed in the lens barrel;
a magnetic element slidably disposed in the lens barrel;
a second lens secured in the magnetic element; and
an electromagnetic element secured in the lens barrel, the electromagnetic element being connected to an electric circuit.
